(19) United States
(12) Patent Application Publication
(10) Pub. No.: US 2026/0047714 A1
(43) Pub. Date: Feb. 19, 2026

(54) FOOD MINCERS AND KITCHEN TOOLS WITH TEARING SAFETY BLADES

(71) Applicant: Arthur Ganson, Harvard, IL (US)

(72) Inventor: Arthur Ganson, Harvard, IL (US)

(21) Appl. No.: 19/296,540

(22) Filed: Aug. 11, 2025

Related U.S. Application Data
(60) Provisional application No. 63/683,317, filed on Aug. 15, 2024.

(51) Int. Cl. A47J 19/06

(52) U.S. Cl. CPC A47J 19/06

(57) ABSTRACT

Apparatus, systems and methods for kitchen tools and mincers that utilize splitting strips having multiple apexes which operate by tearing food in the place of a traditional sharpened blade. In one illustrative embodiment, a press for mincing a portion of a produce product comprises a receiving chamber, formed as an open top box with a bottom opening. A mincing grill formed from a plurality of splitting strips oriented to define mincing cells is disposed in the receiving chamber across, or above, the lower opening. The splitting strips have a periodic leading-edge profile, including a rounded apex with a leading edge that sweeps down and away from the rounded apex in opposing directions until the sections meet at a bottom land. The same degree of roundness can apply to all of the front facing edges, including the points of the apexes.

### CROSS-REFERENCE TO RELATED APPLICATION

This application claims the benefit of U.S. Provisional Application No. 63/683,317, filed Aug. 15, 2024, the disclosure of which is incorporated herein by reference in its entirety.

### TECHNICAL FIELD

The present disclosure relates generally to kitchen tools including food mincers.

### BACKGROUND

Garlic mincers or presses are intended to mince garlic quickly and easily. Most conventional garlic presses are designed to force garlic cloves through a plate with holes (the grille) as it is pressed by a block, effectively smashing the garlic in the process. These presses are unsatisfactory for various reasons.

One problem with such presses is that, as a consequence of their design, some portion of the garlic tends to remain in the chamber as it is retained on the plate between the holes. This requires the user to either remove and manually mince the remaining garlic or discard it, compromising the primary purpose of the press. While some presses are designed so that the pressing component has protrusions that pass through the holes in the grille, this typically fails to address the plate retaining garlic between the holes. While incrementally more effective than presses with a flat surface for pushing, the problem still persists.

Some garlic presses are designed to force garlic through a grid of traditionally designed interlocking sharp blades, each having a sharpened edge against which the garlic is pressed. The Achilles heel of such presses is that their effectiveness diminishes as the blades become dull with use. As there is no way to easily sharpen the blades, the tool becomes unusable over time.

Another problem with such conventional presses is that the amount of force required to effectively accomplish this task may be considerable, despite the best efforts of designers to both exploit principles of leverage and to provide comfortable handles for the operator.

A kitchen tool that addresses these issues and is easy and safe to use would be an improvement in the art.

### SUMMARY

The present disclosure is directed to apparatus, systems and methods for kitchen tools and mincers that utilize splitting strips having multiple apexes which operate by tearing food in the place of a traditional sharpened blade. In one illustrative embodiment, such a system or apparatus may be formed as a press for mincing a portion of a produce product. The press comprises a receiving chamber, formed as an open top box with a bottom opening. A mincing grill formed from a plurality of splitting strips oriented to define mincing cells is disposed in the receiving chamber across, or above, the lower opening. The splitting strips have a periodic leading-edge profile, including a rounded apex with a leading edge that sweeps down and away from the rounded apex in opposing directions until the sections meet at a bottom land. The same degree of roundness can apply to all of the front facing edges, including the points of the apexes.

A pressing block may be present, sized and shaped to enter the receiving chamber and press any material therein through the splitting strips and bottom opening. The pressing block and receiving chamber may be mechanically coupled to one another with a hinge. Counterpart handles may be present on the receiving chamber and pressing block, configured to rotate the pressing block and the receiving chamber toward each other. In some embodiments, the pressing block may include protrusions that pass between the splitting strips and into the mincing cells.

When a produce product is placed in the receiving chamber and pressed into and through the mincing grill, at least portion of the produce product is thereby torn into plural pillars of produce product tissue.

The rounded apexes of the splitting strips may never need to be sharpened like a typical knife edge. Additionally, by avoiding a sharp edge, the splitting strips are unlikely to injure a user through an inadvertent contact.

In some illustrative embodiments, the splitting strips are oriented to define mincing cells. For example, a first plurality of splitting strips extending in a first direction and a second plurality of splitting strips extending in a second direction define the edges of the mincing cells. In some such embodiments, the first plurality of splitting strips and the second plurality of splitting strips may be joined at all points of intersection with the first direction substantially perpendicular to the second direction. In some embodiments, the mincing cells are generally rectangular or generally square in shape. The rounded apexes of each of the plurality of first and second splitting strips may be coincident. In some alternative embodiments, a plurality of splitting strips are arrayed in parallel lines to define the spaces that produce strips of the produce products.

An important advantage of the structure of the splitting strips is that they engage the material to be split incrementally, building up from a single rounded blunt point. Therefore, the effective action is achieved by first “poking” the material and then gradually widening the “poked” hole-essentially tearing as opposed to slicing. For example, when used as a garlic mincer, the tearing of the garlic is more than sufficient to obtain mincing without slicing. Furthermore, the edges of the splitting strips have no edges that are perpendicular to the direction of the movement. Each splitting strip is optimized for tearing the produce product in a single direction perpendicular to the splitting strip, where the material being split is pushed onto it, and past it, starting from the point side of the splitting strip.

Other features and advantages of the invention are apparent from the following description, and from the claims.

### BRIEF DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIG. 1A is a side perspective view of a first illustrative apparatus in accordance with the principles of the present disclosure, for use as a garlic press.

FIG. 1B is a side view of an alternative pressing block for the system of FIG. 1A.

FIGS. 2A and 2B are bottom plan views of mincing grill assemblies for the systems of FIGS. 1A and 1B.

FIG. 3 is top perspective view of the mincing grill of FIG. 2A.

FIG. 4 illustrates some of the general parameters which determine the effectiveness of a splitting strip in accordance with the principles of the present disclosure.

FIGS. 5, 6, 7 and 8 are sectional side views of the system of FIG. 1A depicting the system in use for mincing a produce product.

### DETAILED DESCRIPTION

The present invention relates to apparatus, systems and methods related to kitchen tools that operate by tearing action. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention.

As discussed previously, herein, illustrative embodiments of systems and apparatus in accordance with present disclosure utilize unique splitting strips with an array of aligned tapering structures with rounded tips. These splitting strips have an upper toothed region and a lower structural region. The upper toothed region typically has a periodic leading-edge profile formed by a plurality of aligned rounded apexes, each with a leading edge that sweeps down and away from the rounded apex in opposing directions until the adjacent sections meet at a bottom land. These strips are designed to engage the material to be split incrementally, building up from each single rounded point. These splitting strips do not have sharp edges. In some embodiments, the same degree of roundness can apply to all of the front facing edges of a strip.

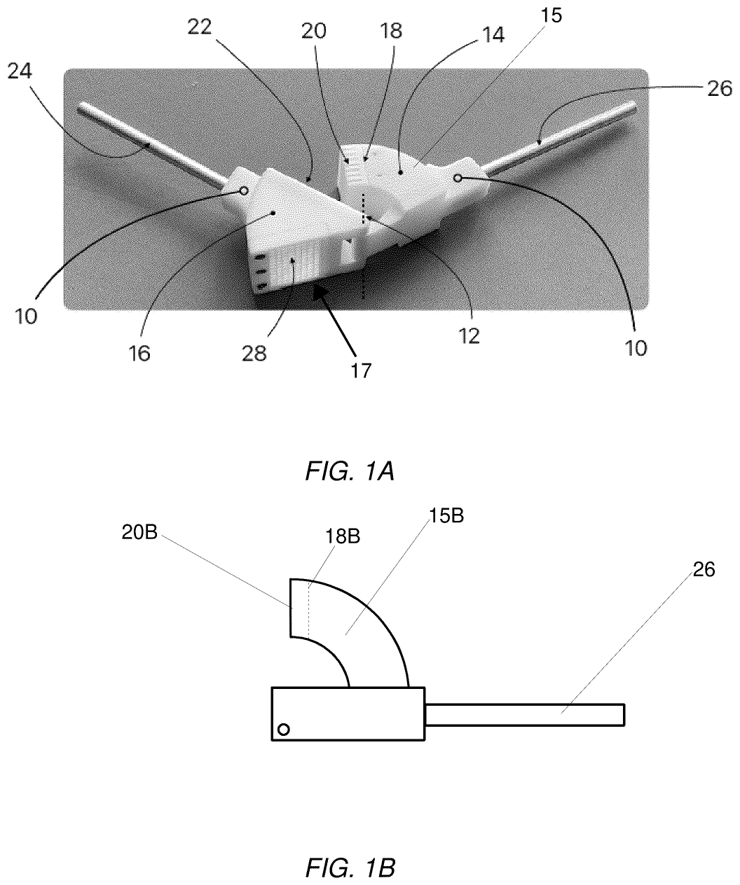

Referring to FIG. 1A, a first embodiment of a system 10 for mincing a produce product is depicted. In one illustrative use, system 10 may be used as a garlic press. System 10 has a hinge 12 that couples a pressing block assembly 14 and a receiving block assembly 16 to each other. The receiving block assembly 16 is generally formed as a body with a central chamber 22 accessed from an open top. Chamber 22 may have generally parallel vertical sidewalls and a bottom opening 17. A mincing grille 28 is disposed in the bottom opening. As depicted, the mincing grill 28 may be formed as a separate member that is attached to the receiving block body, or may be formed as an integral art of the body.

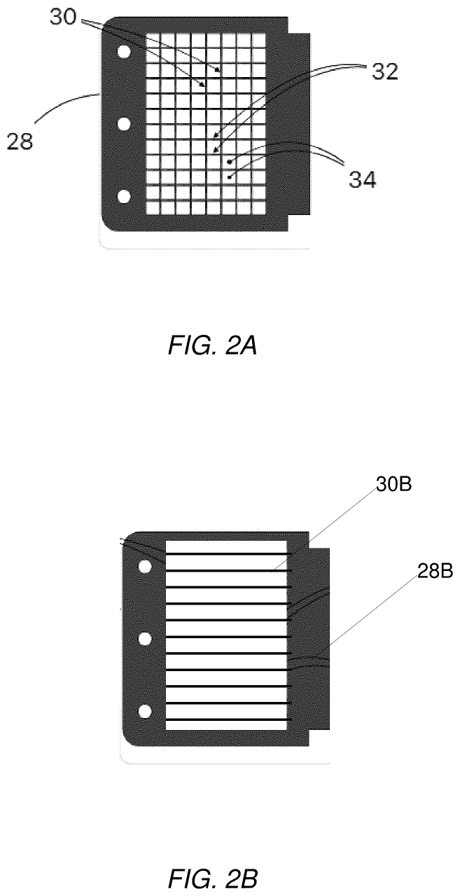

Referring now to FIG. 2A, a mincing grille 28 is depicted. Mincing grille 28 includes an outer frame surrounding a mincing area formed as an opening. The frame may provide for attachment to the receiving assembly as with the depicted flange and fastener holes. A first set of splitting strips 30 extend across the splitting area of the mincing grill 28 parallel to one another in a first direction. A second set of splitting strips 32 extend parallel to one another across the splitting area of the mincing grill 28 in a second direction. In the illustrated embodiment, the first and second sets of splitting strips 30 and 32 extend in directions that are perpendicular to each other. The intersections of the first and second splitting strips 30, 32 define an array of mincing cells 34. In preferred embodiments, the splitting strips 30, 32 are joined at all points of intersection, thereby making the mincing grille 28 one piece for maximum strength. It will be appreciated that the numbers of splitting strips in the sets may be varied in different embodiments to obtain minced products of desired sizes.

Referring now to FIG. 2B, a mincing grille 28B is depicted. Mincing grille 28B includes an outer frame surrounding a mincing area formed as an opening. The frame may provide for attachment to the receiving assembly as with the depicted flange and fastener holes. A single of set splitting strips 30B extends across the splitting area of the mincing grill 28 parallel to one another in a first direction.

Returning to FIG. 1A, pressing block assembly 14 has a block portion 15 which is sized and configured to correspond to chamber 22 of the receiving block assembly, with sidewalls that closely mirror those of the receiving assembly when inserted in chamber 22. In the depicted embodiment, the sidewalls of the block portion 15 are curved to facilitate insertion during operation. In other embodiments, as depicted in FIG. 1A, the pressing face 18 may feature protrusions such as the array of protruding fingers 20. Block portion 15 and the array of protruding fingers 20 are sized to slip fit into the chamber 22 upon rotation, such that the fingers 20 pass into the mincing cells. The array thus mirrors the shape and pattern of mincing grille 28.

As depicted in FIG. 1B, in some embodiments, block portion 15B may have a pressing face 18B which features protrusions such as the array of protruding elongated tabs 20B. Block portion 15B and the array of protruding elongated tabs 20B are sized to slip fit into the chamber 22 upon rotation, such that the tabs 20B pass into the spaces between the parallel splitting strips 30B (depicted in FIG. 2B) and into the mincing cells. The array thus mirrors the shape and pattern of mincing grille 28B.

In these depicted embodiments, first and second handles 24, 26 extend from the pressing block assembly 14 and the receiving block assembly 16, respectively. By using the first and second handles 24, 26, a user can rotate the pressing block assembly 14 and the receiving block assembly 16 for use. It will be appreciated that in other embodiments, the pressing block assembly and receiving block assembly may be formed as separate members that are not joined by a hinge. For example, the receiving block assembly and pressing block assemblies could be standalone members for use by direct rather than rotational pressing. Alternatively, they could be arranged in a linear alignment to one another one for pressing together.

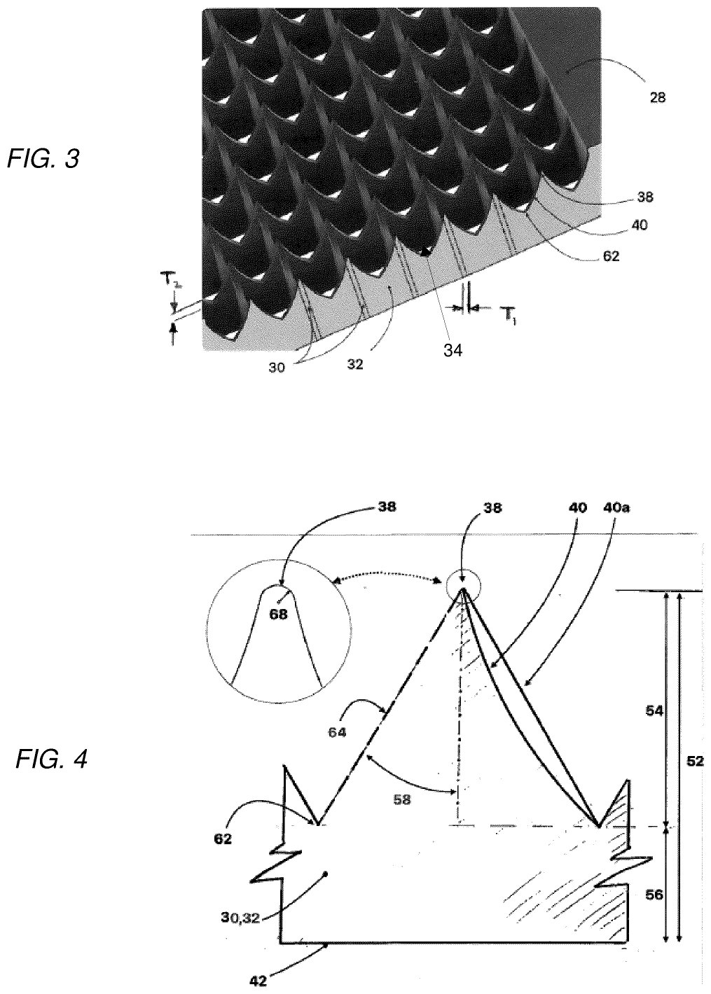

Turning to FIG. 3, a detail of a top portion of mincing grill 28 is depicted, showing the pluralities of splitting strips 30 and 32, and the upper toothed regions and thereof. As depicted, the upper toothed regions have a periodic leading-edge profile formed by plurality of aligned rounded apexes, each with a leading edge that sweeps down and away from the rounded apex in opposing directions until the adjacent sections meet at a bottom land.

Splitting strips 30 and 32 each have a width or thicknesses (T1, T2). The respective widths may vary based on the material used to fabricate the splitting strips as well as the type of food product that is intended to be split or minced. For example, where system 10 is intended for use as a garlic press, the splitting strips may be formed from stainless steel and have a thickness in the range between about 0.25 mm and about 0.75 mm. For example, the strips may be about 0.5 mm in width. In other embodiments, the thickness of the splitting strips can be larger than the 0.25 mm to 0.75 mm range which may be useful for different foodstuffs. Splitting strips 30, 32 can also be formed of other rigid materials including aluminum and plastic materials that are injection molded or 3D printed.

In the illustrated embodiment, the mincing cells 34 are generally square in shape. It will be appreciated that embodiments may include those in which the mincing cells 34 are polygons having three sides, or, are polygons having more than three sides. These are readily constructed by orienting splitting strips in the relevant directions.

Splitting strips 30, 32 have a periodic leading-edge profile 40 resembling the shape of a series of shark teeth joined at their bases. Each cell section 34 begins with a rounded apex 38, with a leading edge 40 that sweeps down and away from the apex 38 in opposing directions until the sections meet at the bottom land 62, forming one continuous splitting strip 30, 32. As depicted, in FIG. 3 the point apexes 38 of splitting strips 30, 32 are preferably coincident to facilitate splitting and provide for stronger structure. However, it will be appreciated that embodiments where pluralities of splitting strips are joined at the bottom lands or at another point on the profiles may be used for particular applications. It will be appreciated that alternative embodiments with mincing grills where the splitting strips are formed as an array defining polygonal cells (e.g., hexagonal or octagonal cells) are also contemplated.

Turning to FIG. 4, a cross section of a portion of a single splitting strip 30 or 32 is depicted. The overall depth 52 (measured from the tip 38 to trailing edge 42) comprises two regions—the lower structural region indicated by dimension 56, and the upper toothed region, indicated by dimension 54. In practice, the overall depth 52 will be determined by the strength of the material from which the splitting strip 30, 32 is made. Any materials suitable for food contact and having sufficient strength may be used.

Leading edge 40 references underlying line segment 64 which spans from tip 38 to bottom land 62 and is set at an angle 58. In practice, angle 58 is about 45 degrees or less. Also shown in FIG. 4, the leading edge may be concave 40 or straight 40a. Logically, a concave leading edge 40 leads to a sharper tip 38. Tip 38 may have a radius 68. As depicted, a preferred radius 68 is not sharp point but is rounded. Such a preferred radius allows an operator to gently press a finger against it and not be easily pricked-thereby making it safe to touch.

In some embodiments, the diameter of a tip on a splitting strip may generally be equal to the width of the splitting strip. The rounded top of the tip is generally blunt. In one illustrative embodiment, the splitting strip 30 has a width of about .37 mm with a radius at the rounded point of about .185 mm and a generally square mincing cell 34 size of about 2 mm per side. In another, the splitting strip 30 and tip 68 may have a width as small as about .16 mm, with corresponding radius as small as about .08 mm. It will be appreciated that these values are exemplary and any suitable radius and width that provides for a rounded tip may be used. It will further be appreciated that embodiment having a taper where the splitting strip 30 is thicker on the pointed side may also be used, this could facilitate cut material flowing more easily through the mincing cells 34, as each mincing cell 34 cross-sectional area increases in size as the material moves through the grid.

It will be appreciated that the unique splitting strips can provide a safer way for a user to mince a produce product such as garlic, when compared to the use of a device with sharpened blades through the elimination of cutting edges, found in standard elongated or serrated knife style blades. It will be further appreciated that the use of pluralities of splitting strips 30 can provide further safety for a user, by additionally decreasing the chance of injury. In the case of inadvertent contact of a finger, by spreading the contact over multiple rounded tips, the pressure at any particular tip is lessened, similar to a “bed of nails”, this reducing the likelihood of cutting or damaging the user's finger.

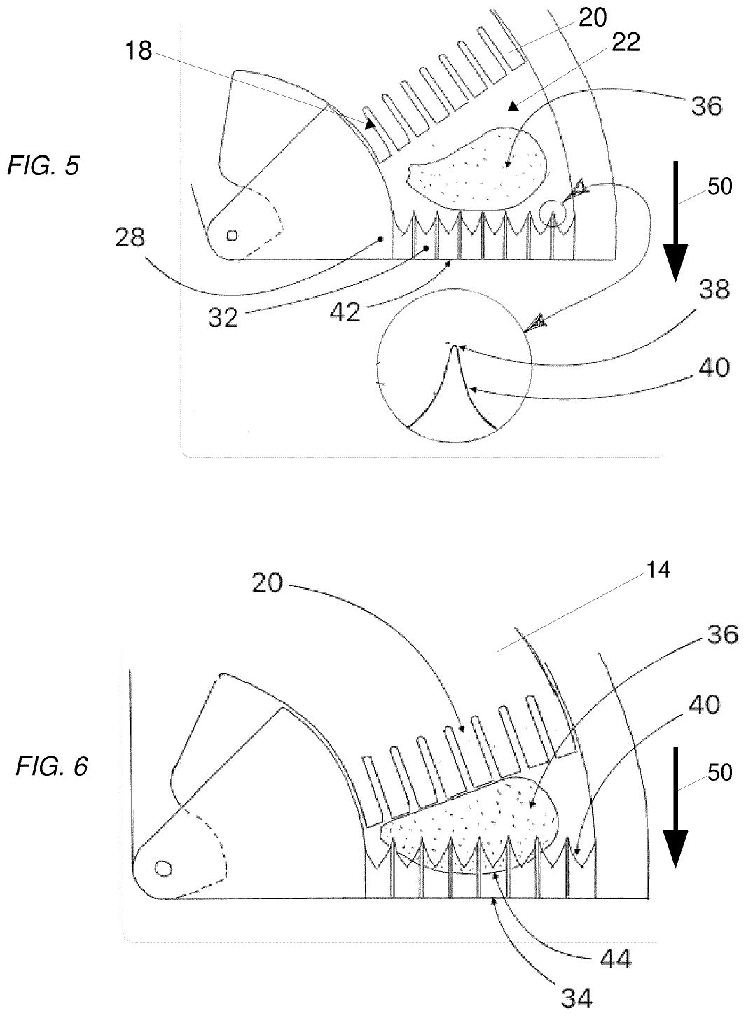

FIGS. 5, 6, 7 and 8 are sectional side views of the system of FIG. 1A depicting the system in use for mincing a produce product.

FIG. 5 depicts a produce product 36, such as a garlic clove in receiving chamber 22 resting on the upper surface of mincing grill 28. Also shown in FIG. 5 is a closeup of a splitting strip 32 showing rounded apex 38 and leading edge 40. The produce product 36 rests only on the rounded apexes 38. As a result, only a small force is required to initially puncture the produce product 36. As a function of this shape, at no point is the garlic clove 36 presented with a leading edge 40 perpendicular to its direction of travel 50.

With the produce product 36 in place, pressing block 14 is advanced in chamber 22, contacting the produce product 36 and advancing it on to the mincing grill 28. FIG. 6 depicts produce product 36 in the initial stages of mincing. Tips 38 of the splitting strips puncture the tissue of the produce product. As the pressing block 14 forces the produce product downwards, the produce product moves downwards and the leading edge 40 of the strips causes the tissues to tear. As the produce product 36 is further pressed, the aligned tears in the produce product meet. The produce product 36 tissue begins to be torn and divided into an individual pillar 44 of tissue in each mincing cell 34 that the produce product passes through, as depicted in FIG. 7. Since the mincing cells 34 are all the same size, these pillars 44 of produce product tissue have the same cross section.

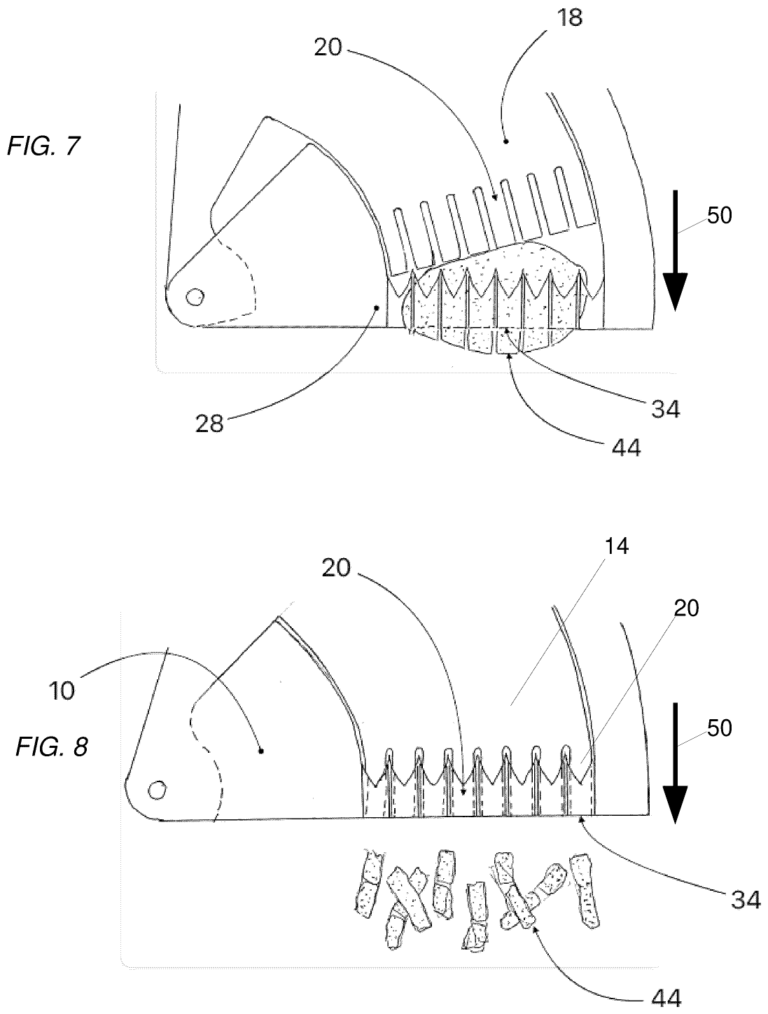

As shown in FIG. 8, where pressing block 14 includes an array of protrusions 18, each protrusion 20 travels all the way through its corresponding mincing cell 34, thereby pushing the pillars 44 of produce product 36 completely out of the system 10 altogether. This avoids the residual tissue that remains uncut in a conventional garlic press. As depicted, the fingers 20 and mincing cells 34 are dimensioned to provide a close slip fit tolerance between the moving surfaces to minimize the amount of tissue remaining in the fingers 20 or cells 34 after use.

In contrast to a conventional garlic press that smashes garlic against a metal plate with holes, mincing grill 28 with its individual mincing cells 34, shark-shaped splitting strips 30, 32, and correspondingly sized fingers 20 provide for segments that are truly minced rather than bluntly fragmented. When used for garlic, a true “mincing” of the garlic is achieved by the splitting strips' ability to progressively penetrate the garlic clove tissue with less friction resulting in uniformly sized segments. Because of the anatomical structure of garlic and its taxonomic cousins, the pillars 44 for these produce products will naturally fall apart along the lines of cleavage present in the tissue.

While this disclosure has described certain embodiments, the present invention can be further modified with the spirit and scope of this disclosure. This application is therefore intended to cover any variations, uses, or adaptations of this disclosure using its general principles. Further, this application is intended to cover such departures from the present disclosure as come within known or customary practices in the art to which this invention pertains and which fall within the limits of the appended claims.

What is claimed is:

1. A press for mincing a produce product, comprising:
a receiving block comprising a chamber with a surrounding sidewall, a top opening and a bottom opening;
a mincing grill disposed in the receiving block and covering the bottom opening, the mincing grill comprising a plurality of splitting strips, each splitting strip of the plurality of splitting strips having a periodic leading-edge profile including a rounded apex with a leading edge that sweeps down and away from the rounded apex in opposing directions until the sections meet at a bottom land between adjacent apexes;
a pressing block sized and received to enter the chamber and press any produce product therein into the mincing grill to thereby mince the produce product by tearing.

2. The press of claim 1, wherein the plurality of splitting strips comprises a first plurality of splitting strips extending in a first direction and a second plurality of splitting strips extending in a second direction.

3. The press of claim 2, wherein the first direction is substantially perpendicular to the second direction.

4. The press of claim 3, wherein the first plurality of splitting strips and the second plurality of splitting strips are joined at all points of intersection.

5. The press of claim 4, wherein the rounded apexes of each of the first plurality of splitting strips and the second plurality of splitting strips are coincident.

6. The press of claim 2, wherein the first plurality of splitting strips and the second plurality of splitting strips define square mincing cells.

7. The press of claim 1, wherein the plurality of splitting strips includes an upper toothed region and a lower structural region.

8. The press of claim 7, wherein the leading edges of the upper toothed region are at an angle of 45 degrees or less referenced from an underlying line segment or the lower structural region.

9. The press of claim 1, wherein the leading edges are concave.

10. The press of claim 1, wherein the leading edges are straight.

11. The press of claim 1, wherein the receiving block is mechanically coupled to the press block with a hinge.

12. The press of claim 1, wherein the mechanical linkage includes first and second handles configured to rotate the press block and the receiving block toward each other.

13. The press of claim 1, wherein the plurality of splitting strips has a thickness in the range of from about 0.25 mm to about 0.75 mm.

14. The press of claim 13, wherein the plurality of splitting strips has a thickness of about 50 mm.

15. The press of claim 1, further comprising a mechanical linkage that receives mechanical energy and uses the mechanical energy to cause the pressing block to enter the chamber and press any produce product therein into the mincing grill to thereby mince the produce product by tearing.

16. A mincing grill for a mincer, comprising:
a plurality of splitting strips, each splitting strip of the plurality of splitting strips having a periodic leading-edge profile including a rounded apex with a leading edge that sweeps down and away from the rounded apex in opposing directions until the sections meet at a bottom land between adjacent apexes.

17. The mincing grill of claim 16, wherein the plurality of splitting strips comprises a first plurality of splitting strips extending in a first direction and a second plurality of splitting strips extending in a second direction.

18. The mincing grill of claim 17, wherein the first direction is substantially perpendicular to the second direction.

19. The mincing grill of claim 18, wherein the first plurality of splitting strips and the second plurality of splitting strips are joined at all points of intersection.

20. The mincing grill of claim 16, wherein the plurality of splitting strips includes an upper toothed region and a lower structural region.

21. The mincing grill of claim 20, wherein the leading edges of the upper toothed region are at an angle of 45 degrees or less referenced from an underlying line segment or the lower structural region.

22. The mincing grill of claim 16, wherein the leading edges are concave or straight.

23. The mincing grill of claim 16, wherein the plurality of splitting strips has a thickness in the range of from about 0.25 mm to about 0.75 mm.
